(19) United States
(12) Patent Application Publication
(10) Pub. No.: US 2005/0247740 A1
(43) Pub. Date: Nov. 10, 2005

(54) Pneumatic dispensing device with frangible seal breaker and method

(76) Inventor: Daniel Puzio, Baltimore, MD (US)

Correspondence Address: HARNESS, DICKEY & PIERCE, P.L.C., P.O. BOX 828, BLOOMFIELD HILLS, MI, 48303, US

(21) Appl. No.: 10/841,244

(22) Filed: May 7, 2004

(51) Int. Cl. B67B 7/00

(52) U.S. Cl. 222/389

(57) ABSTRACT

Product cartridges that include a frangible seal are used for construction adhesives, sealants and caulks. A housing retains the product cartridge and cooperates therewith to form a gas enclosure separated from a product enclosure by a piston. A plunger is adapted to transfer a force to the piston to break the frangible seal of the product cartridge. In addition, the dispensing device provides pressurized gas to the gas enclosure to generate a force sufficient to dispense product from a dispensing orifice of the product cartridge. A method of enabling product to be dispensed from such cartridges includes associating a seal breaking mechanism with the dispensing device that can exert a frangible seal breaking force on the product cartridge. A separate dispensing mechanism is also associated with the dispensing device that can exert a product dispensing force on the product cartridge.

### FIELD OF THE INVENTION

The present invention relates to pneumatic dispensing devices for product cartridges; and more particularly, to such dispensing devices for product cartridges which have a frangible seal.

### BACKGROUND OF THE INVENTION

Some viscous products, including for example, adhesives, caulks, and sealants, are commonly packaged in product cartridges or tubes. These tubes typically include a cardboard or plastic cylindrical body and a piston that operates as a moveable wall to push product from the product cartridge. In some cases, the piston is attached to the cylindrical body by a frangible seal. Thus, the frangible seal holds the piston in place and must be broken before the piston can move to push product from the product cartridge. Breaking the frangible seal can require the application of a relatively high force to the piston.

Pneumatic dispensing devices for dispensing product from product cartridges or tubes are generally incapable of exerting enough pressure on the piston to generate a sufficiently high force on the piston to break the frangible seal. Even if such a high force were to be generated against the piston by a pneumatic dispensing device the resulting pressure would tend to be significantly higher than that desirable for optimal product dispensing. Thus, it has been discovered that a pneumatic dispensing device for product cartridges is desirable that includes a separate mechanism to break a frangible seal.

### SUMMARY OF THE INVENTION

In accordance with one aspect of the present invention, a pneumatic dispensing device is provided. The dispensing device is adapted to dispense product from a product cartridge having a frangible seal. A housing is adapted to retain the product cartridge and is adapted to cooperate with the product cartridge to form a gas enclosure separated from a product enclosure by a piston. A plunger is adapted to transfer a force to the piston to break the frangible seal of the product cartridge. In addition, the dispensing device is adapted to provide pressurized gas to the gas enclosure to generate a force sufficient to move the movable piston to dispense product from a dispensing orifice of the product cartridge.

In accordance with another aspect of the present invention, a pneumatic dispensing device for dispensing product from a product cartridge having a frangible seal is provided. The dispensing device includes a product cartridge housing component that is adapted to retain the product cartridge and is adapted to cooperate with the product cartridge to form a gas enclosure separated from a product enclosure by a piston. A fluid passage provides fluid communication between an inlet and the gas enclosure. A gas cartridge housing component is adapted to retain a pressurized gas cartridge and is adapted to seal the pressurized gas cartridge in fluid communication with the inlet. A plunger has an external end and an internal end. The plunger is sealed to the product cartridge housing component between the internal end and the external end. The internal end extends into the gas enclosure and the external end extends outwardly of the housing. The plunger is adapted to transfer a force applied to the external end of the plunger to the piston to break the frangible seal of the product cartridge. The dispensing device is further adapted to provide pressurized gas from the pressurized gas cartridge to the gas enclosure to generate a force sufficient to move the piston to dispense product from a dispensing orifice of the product cartridge.

In accordance with yet another aspect of the present invention, a method of enabling product to be dispensed from a product cartridge having a frangible seal using a dispensing device is provided. The method includes associating a seal breaking mechanism with the dispensing device that is adapted to exert a frangible seal breaking force on the product cartridge. A separate dispensing mechanism is also associated with the dispensing device that is adapted to exert a product dispensing force on the product cartridge.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional illustration of a dispensing device in accordance with one preferred embodiment of the present invention;

FIG. 2 is a perspective view of the dispensing device of FIG. 1, illustrating the striking of the seal breaker against a surface;

FIG. 3 is a cross-sectional illustration of the device of FIG. 1 during the striking operation of FIG. 2; and

FIG. 4 is a cross-sectional illustration of the device of FIG. 1 during a dispensing operation.

### DETAILED DESCRIPTION OF THE PREFERRED EMBODIMENTS

The following description of the preferred embodiment is merely exemplary in nature and is in no way intended to limit the invention, its application, or uses. For example, although the frangible seal is described herein as being associated with a piston of the product cartridge, the frangible seal may be associated with other components of the product cartridge, such as the dispensing orifice.

As used herein, “pressurized gas cartridge” means a container that is capable of housing a material that can be dispensed from the container in the form of a pressurized gas. Thus, it is possible that the material inside the container may be, at least partially, in a form that is not gaseous. Similarly, the phrase “product cartridge” as used herein, means a container capable of housing a product for shipping and/or storage and for dispensing. Thus, the term “cartridge” does not, in itself, require any specific structural configuration.

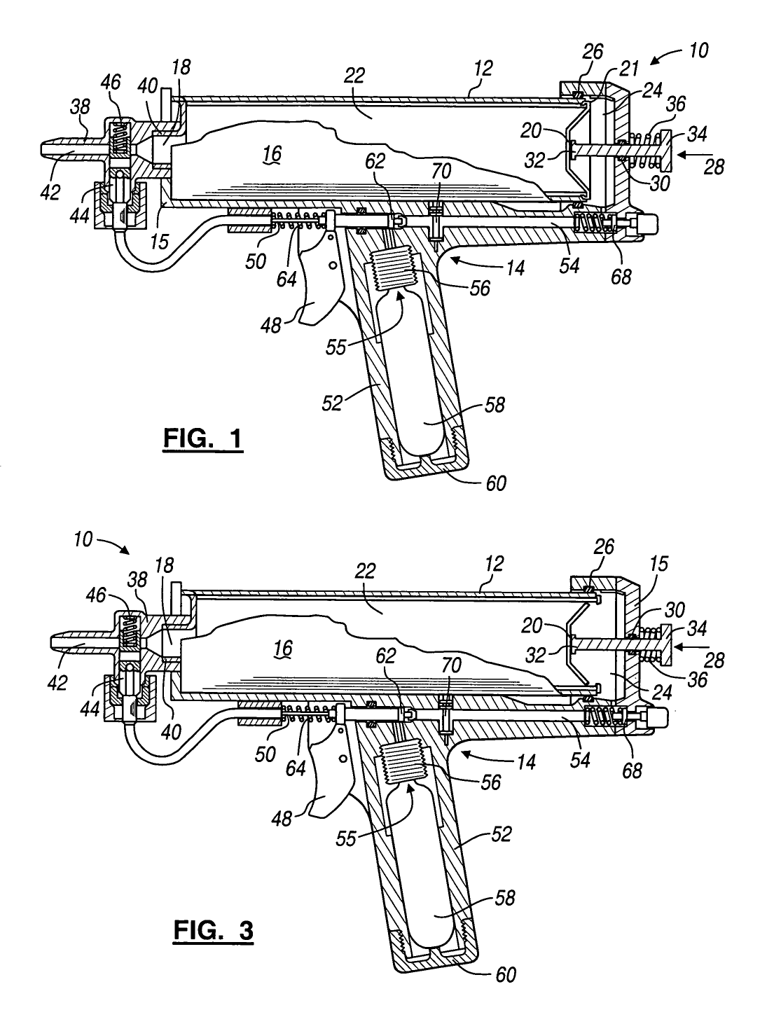

Referring to FIGS. 1 through 4, one preferred embodiment of a dispensing device 10 for dispensing a viscous product from a viscous product cartridge 12 is illustrated. The dispensing device 10 includes a housing 14. The housing 14 includes an upper portion 15 that operates as a product cartridge housing component. This product cartridge housing component 15 is adapted to retain the viscous product cartridge 12. In the illustrated embodiment, the viscous product cartridge 12 is a cylindrical tubular member having a relatively rigid cylindrical wall 16. For example, the cylindrical wall 16 may be formed of cardboard or plastic. Such tubular cartridges 12 are commonly used in conjunction with or in association with construction adhesives, sealants and caulk.

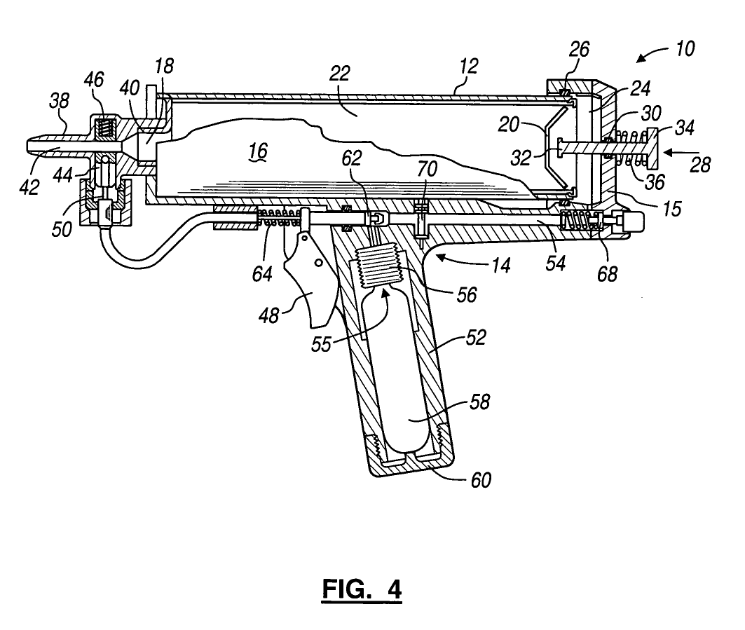

At one end of the cylindrical tubular product cartridge 12 is a dispensing orifice 18. The dispensing orifice 18 may be provided, for example, by cutting the end of a nozzle (not seen) that is typically provided on many such commercially available viscous product cartridges 12. At the opposite end of the product cartridge 12 is a piston 20 that seals the end of the tube. A frangible seal 21 attaches the piston 20 to the outer wall 16 of the product cartridge 12 as seen in FIG. 1. Once the frangible seal 21 is broken, the piston 20 can operate as a movable wall 20 that is capable of forcing product from the product enclosure 22 through the dispensing orifice 18 as the piston 20 moves toward the dispensing orifice 18 as seen in FIG. 4.

In addition or as an alternative, it may be necessary to rupture an internal thin film seal (not shown) at the base of the nozzle that seals the dispensing orifice 18 and is often included in such commercially available product cartridges. Thus, such an internal thin film seal across the dispensing orifice can provide an additional or alternative frangible seal that is ruptured upon actuation of the plunger as discussed below.

Although this embodiment has a relatively rigid cylindrical wall 16 and a movable piston 20, an alternative product cartridge (not shown) is made of flexible thin-film packaging material. The corresponding product cartridge housing component is modified to be sealed around the flexible side walls in this alternative embodiment providing a gas enclosure that surrounds the flexible side walls. Thus, the side walls can move toward each other under external pressure within the gas enclosure to force product through the dispensing orifice. Accordingly, the flexible thin-film side walls provide the movable walls in this alternative embodiment.

As indicated above, the upper portion of the housing 14 operates as a product cartridge housing component 15. The product cartridge housing component 15 is adapted to cooperate with the viscous product cartridge 12 to form a gas enclosure 24 separated from the product enclosure 22 by the piston wall 20. In this embodiment, the product cartridge housing component 15 is sealed to the cylindrical outer wall 16 of the product cartridge 12 using an O-ring 26 to form a gas enclosure 24 between the housing component 15 and the product cartridge 12. The piston 20 or movable wall separates the gas enclosure 24 from the product enclosure 22 formed inside the product cartridge 12.

A frangible seal breaker is also associated with the upper portion 15 of the housing 14. Specifically, a plunger 28 is sealed to the housing by an O-ring 30. The plunger 28 includes an internal end 32 inside the housing component 15 that is located adjacent the product piston 20. The plunger 28 also includes an external end 34 located outside the housing 14. A spring 36 biases the plunger 28 to an outward position. Although the outward position of the plunger 28 is illustrated with the internal end 32 in close proximity with piston 20, the internal end 32 is alternatively spaced some distance away from the product piston 20 by the biasing spring 36. The plunger 28 is adapted for contact with an object outside the dispensing device 10 and to transfer the force resulting from the contact to the piston 20.

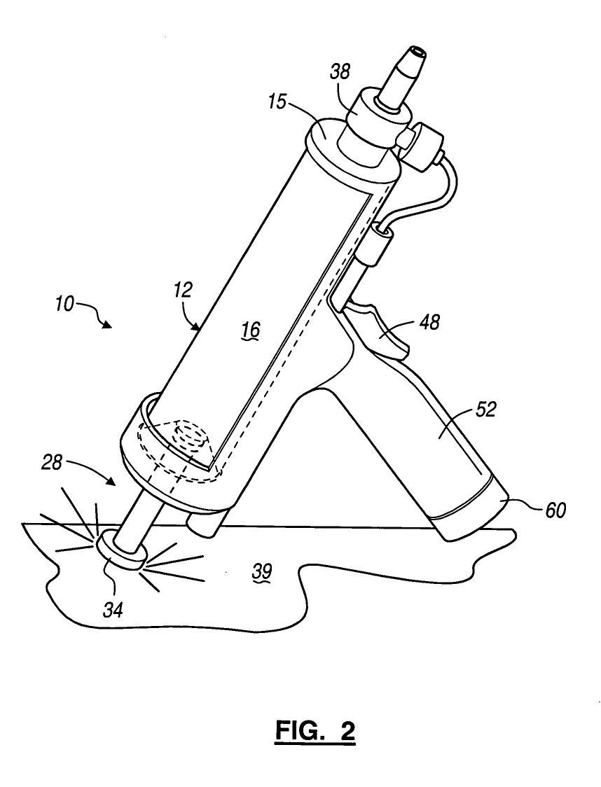

Referring to FIGS. 2 and 3, the dispensing device 10 is illustrated as having been moved to contact the plunger 28 against a stationary object 39. Alternatively, the dispensing device 10 may be held stationary and another object may be moved to contact against the plunger 28. In either event, a force is generated against the external end 34 of the plunger 28. Thus, the external end 34 of the plunger 28 is adapted for contact with another object. As a result of the contact, the plunger 28 moves inwardly against the biasing force of the spring 36 and contacts with the product piston 20.

Referring to FIG. 3, the internal end 32 of the plunger 28 contacts the product piston 20 and transfers a momentary force thereto. This momentary force causes the frangible seal 21 between the piston 20 and the outer wall 16 of the product cartridge 12 to break. Thereafter, the plunger 28 returns to its outward position under the influence of the biasing spring 36 as seen in FIG. 4. Thus, the force is a temporary force that dissipates almost immediately upon breaking the frangible seal 21. Thus, the plunger 28 provides a seal breaking mechanism.

The frangible seal breaking force is applied to the piston 20 and dissipated prior to the application of a dispensing force. In addition, the frangible seal breaking force is applied as a result of a mechanism (including plunger 28) that is separate from the pneumatic mechanism that applies a force to the piston 20 for dispensing of product from the product cartridge 12. This frangible seal breaking mechanism relies upon direct physical contact with the product cartridge 12 in order to apply the frangible seal breaking force to the product cartridge 12. In contrast, the mechanism that applies a force to the product cartridge 12 to dispense product therefrom relies upon pneumatic pressure as discussed below. Thus, not only are these mechanisms separate, but they also operate using different means to transfer the force to the product cartridge 12.

The upper portion of the housing 14 also includes a nozzle housing component 38 which is adapted to seal with a wall 40 of the product cartridge 12 that surrounds the dispensing orifice 18. As indicated above, this wall 40 can be provided by trimming the end of a nozzle from a standard caulk or adhesive product cartridge 12. A rubberized gasket (not shown) may be provided between the nozzle housing component 38 and the wall 40 of the product cartridge 12 to facilitate this seal. As another possible alternative, threads (not shown) may be provided to enable threaded engagement between the wall 40 of the product cartridge 12 and the nozzle housing component 38 to facilitate the seal therebetween.

The nozzle housing component 38 includes a dispensing passage 42 which is selectively opened and closed by a valve body 44. A spring 46 biases the valve body 44 downwardly into a closed position in which the dispensing passage 42 of the nozzle 38 is sealed as seen in FIGS. 1 and 3. Actuation of a manually operated trigger 48 causes a cable 50 to counteract the biasing force of the spring 46 and push the valve body 44 upwardly into a dispensing or open position as seen in FIG. 4. In this open position, product can be dispensed from the product cartridge 12 through the dispensing orifice 18 of the product cartridge and the dispensing passage 42 of the nozzle housing component 38.

In an alternative embodiment (not seen), the nozzle, including the valve body and dispensing passage, may be integrally provided as part of the product cartridge, rather than as part of the dispensing device housing 14. This configuration eliminates the need to seal the dispensing orifice 18 of the product cartridge 12 and the dispensing passage 42 of the cartridge housing component 15 together. In contrast, the preferred embodiment described above enables re-use of the nozzle housing component 38 and valve 44 assembly with multiple disposable product cartridges 12.

As indicated above, a lower portion 52 of the housing 14 of the dispensing device 10 operates as a handle for manually grasping the dispensing device 10. The manually actuated trigger 48 mentioned above is associated with the handle 52. In addition, the handle provides a gas cartridge housing component 52. A fluid passage 54 provides fluid communication between the gas enclosure 24 and an inlet 55 associated with a pressure regulator 56 located in the handle portion 52 of the housing 14. The gas cartridge housing component 52 is adapted to retain a gas cartridge 58 in sealed fluid communication with the inlet 55.

Specifically, the inlet 55 of the fluid passage 54 includes a resilient gasket seal member (not seen). In addition, the inlet 55 may include a piercing member (not seen) to pierce an opening in the gas cartridge 58 upon sealing to the inlet 55. The gas cartridge housing component 52 includes a screw on cap 60 associated with the gas cartridge 58. As the cap 60 is screwed onto the remainder of the gas cartridge housing component 52, the cap 60 pushes the gas cartridge 58 into sealing engagement with the gasket of the inlet 55. In addition, screwing the cap 60 onto the remainder of the gas cartridge housing component 52 causes any piercing member to pierce the gas cartridge 58. In any event, sealed fluid communication is provided between the interior of the gas cartridge 58 and the fluid passage 54.

The pressure regulator 56 reduces the pressure of the CO₂ gas flowing from the pressurized CO₂ cartridge 58 to a lower pressure level. This lower level of pressure is high enough to dispense product from the product cartridge 12 at a desirable rate. Thus, the pressure regulator 56 receives gas from the fluid passage at a relatively high pressure at an inlet side toward the CO₂ cartridge 58 and, after converting the gas to a reduced pressure, discharges the CO₂ gas from an outlet side of the pressure regulator 56 into the fluid passage 54 toward the gas enclosure 24.

A gas flow control valve 62 is also located along the fluid passage 54. The gas flow control valve 62 is biased to a closed position by a spring 64. The gas flow control valve 62 is manually actuated by the trigger 48 which moves the valve 62 to an open position as seen in FIG. 4. In the open position, gas is permitted to travel along the passage 54 from the pressurized CO₂ cartridge 58 and to the gas enclosure 24. The resulting increase in gas within the gas enclosure 24 causes the pressure to increase until the piston 20 begins to move.

As indicated above, the trigger 48 is also connected to the nozzle valve body 44 to open the valve upon manual actuation. Thus, in this embodiment, the valve 44 of the dispensing passage 42 and the gas flow control valve 62 are simultaneously opened. As the piston 20 begins to move, a volume of the gas enclosure 24 expands reducing a volume of the product enclosure 22 and dispensing product through the dispensing orifice 18 and the dispensing passage 42. Upon release of the trigger 48, both the nozzle valve 44 and the gas flow control valve 62 move to their closed positions as seen in FIGS. 1 and 3. Thus, the product within the product enclosure 22 is maintained under pressure due to the remaining gas pressure within the gas enclosure 24. Product does not continue to be dispensed, however, due to the valve 44 of the dispensing passage 42 being in a closed position.

Two additional valve mechanisms are located within the fluid passage in this embodiment. One is a pressure release valve 68 that is additionally associated with the gas enclosure 24 and is biased to a closed position. The pressure release valve 68 may be manually moved to an open position to permit the release of pressure from the gas enclosure 24. This release of pressure can, for example, facilitate the replacement of the viscous product cartridge 12. A maximum pressure release valve 70 is also included in the fluid passage 54 that is designed to vent the CO₂ gas from the gas enclosure 24 should the pressure therein exceed a maximum pressure level.

Operation of the dispensing device 10 described above involves locating a product cartridge 12 in the product cartridge housing component 15. As described above, this creates a gas enclosure 24 separated from a product enclosure 22 by a moveable wall 20. In addition, operation of the dispensing device 10 involves locating a CO₂ cartridge 58 inside the gas cartridge retaining housing component 52. The CO₂ cartridge is sealed to the inlet 55 by threading the cap 60 onto the housing 14 as discussed above. Thus, the interior of the CO₂ cartridge 58 is located in sealed fluid communication with an inlet 55 of the passage 54 by screwing on the cap 60.

The plunger 28 is struck against a surface 39 as seen in FIG. 2 and described above. Enough of a force is generated that the physical contact of the plunger 28 against the product piston 20 causes the frangible seal 21 to break. As a result, the product piston 20 is free to move in response to a dispensing force that is less than the frangible seal breaking force. Further, no residual force continues to be exerted on the product piston 20 as a result of the frangible seal breaking mechanism (including plunger 28).

Referring to FIG. 4, application of the product dispensing force is accomplished by manually actuating the trigger 48 which causes opening of both the nozzle valve 44 and gas flow control valve 62. Pressurized gas from the CO₂ cartridge 58 flows through the fluid passage 54 and passes through the pressure regulator 56 where the pressure level of the gas is reduced to an operational pressure level. This pressure level is selected to affect a desirable dispensing rate without unnecessarily increasing the pressure. An adjustment mechanism (not shown) for the pressure regulator 56 may additionally be provided to enable a user to adjust the operating pressure level for different products.

The pressurized gas flows past the open gas flow control valve 62 in the fluid passage 54 and into the gas enclosure 24. As the quantity of gas in the gas enclosure 24 increases, the gas begins to push against the piston 20. Since the nozzle valve 44 is open the piston 20 begins to move, thereby increasing the volume of the gas enclosure 24. Conversely, this movement of the piston 20 decreases the volume of the product enclosure 22. Thus, product is pushed from the product enclosure 22 through the dispensing orifice 18, and the open nozzle valve 44 in the dispensing passage 42. Upon release of the trigger 48, the gas flow control valve 62 closes to cause the flow of gas from the CO₂ cartridge 58 to the gas enclosure 24 to cease as seen in FIGS. 1 and 3. In addition, the product valve 44 in the nozzle 38 closes which causes the flow of product through the dispensing passage 42 to cease.

During product dispensing, the pressure of the gas within the gas enclosure 24 generates a dispensing force that is exerted on the movable piston 20 which is sufficient to move the movable piston 20 to dispense product from a dispensing orifice 18 of the product cartridge 12. The product dispensing force is generally selected to deliver a desirable product dispensing rate and is preferably less than the force required to break the frangible seal. The product dispensing force is preferably less than the equivalent of about 30 psi; more preferably this force is equivalent to between about 15 psi and about 25 psi; and even more preferably, this force is equivalent to about 20 psi.

In contrast, the plunger 28 is adapted to transfer a force to the piston 20 that is sufficient to break the frangible seal 21 of the product cartridge 12. This seal breaking force is preferably greater than the force sufficient to move the piston 20 to dispense product from a dispensing orifice 18 of the product cartridge 12. Preferably, the frangible seal breaking force is equivalent to at least about 40 psi; and more preferably, this force is equivalent to between about 50 psi and about 60 psi.

A method of enabling product to be dispensed from a product cartridge 12 having a frangible seal 21 is accomplished, for example, by providing a dispensing device 10 as described above. The method includes associating a seal breaking mechanism with a dispensing device 10. With reference to the preferred dispensing device 10 described above, this seal breaking mechanism includes the plunger 28. As discussed above, the seal breaking mechanism including plunger 28 is adapted to exert a relatively large frangible seal breaking force on the piston 20 of the product cartridge 12. This seal breaking mechanism causes a momentary impact force to impinge directly upon the piston 20 of the product cartridge 12 to break the frangible seal 21.

The method also includes associating a separate dispensing mechanism with the dispensing device. With reference to the preferred dispensing device 10 described above, this dispensing mechanism is the mechanism including the pressure regulator 56, fluid passage 54 and gas enclosure 24. This separate dispensing mechanism is adapted to exert a product dispensing force on the piston 20 of the product cartridge 12. The product dispensing force is generated by the application of pneumatic pressure on the piston 20 of the product cartridge 12. The product dispensing force is preferably less than the frangible seal breaking force as detailed above.

In addition to associating a frangible seal breaking mechanism and a separate product dispensing mechanism with the dispensing device 10, the user is preferably instructed in the use of the seal breaking mechanism to break the frangible seal 21. The instructions can be provided as part of a package insert or as information printed directly on a package and/or the dispensing device 10. The instructions may also be provided separate from the dispensing device 10 and packaging as part of a print or television advertising campaign.

The method may additionally include associating the product cartridge 12 with the pneumatic dispensing device 10. Further, a source of the pressurized gas can be associated with the device 10. Preferably, this involves associating a pressurized gas cartridge 58 in sealed communication with the dispensing device 10. Once the product cartridge 12 and pressurized gas source 58 is associated with the dispensing device, operation of the device 10 is as previously described above.

Only a small number of the many possible alternatives are described above. Many additional modifications and alternatives beyond those described above, may be envisioned by those skilled in the art. For example, although the illustrated embodiment of the plunger extends both inside and outside the dispensing device housing, the plunger may alternatively be located completely within the housing. In one such alternative, a weighted slide within the housing may be provided that contacts against the product piston upon shaking or otherwise transferring inertia to the weighted slide.

The description of the invention is merely exemplary in nature and, thus, variations that do not depart from the gist of the invention are intended to be within the scope of the invention. Such variations are not to be regarded as a departure from the spirit and scope of the invention.

1. A pneumatic dispensing device adapted to dispense product from a product cartridge having a frangible seal, the pneumatic dispensing device comprising:
a housing adapted to retain the product cartridge and adapted to cooperate with the product cartridge to form a gas enclosure separated from a product enclosure by a piston;
a plunger adapted to transfer a force to the piston to break the frangible seal of the product cartridge;
wherein the dispensing device is adapted to provide pressurized gas to the gas enclosure to generate a force sufficient to move the movable piston to dispense product from a dispensing orifice of the product cartridge.

2. A pneumatic dispensing device according to claim 1, wherein the plunger has an external end extending outside of the housing and an internal end located inside the housing.

3. A pneumatic dispensing device according to claim 2, wherein the plunger is adapted to transfer a momentary force that is impacted upon the external end of the plunger to the piston.

4. A pneumatic dispensing device according to claim 1, wherein the frangible seal is associated with the piston.

5. A pneumatic dispensing device according to claim 1, further comprising a biasing member to bias the plunger away from the piston.

6. A pneumatic dispensing device according to claim 1, wherein the plunger is adapted to transfer a force to the piston that is greater than the force sufficient to move the piston to dispense product from a dispensing orifice of the product cartridge.

7. A pneumatic dispensing device according to claim 1, further comprising a pressurized gas cartridge to provide pressurized gas to the gas enclosure.

8. A pneumatic dispensing device for dispensing product from a product cartridge having a frangible seal, the pneumatic dispensing device comprising:
a product housing component adapted to retain the product cartridge and adapted to cooperate with the product cartridge to form a gas enclosure separated from a product enclosure by a piston;
a fluid passage providing fluid communication between an inlet and the gas enclosure;
a gas supply housing component adapted to retain a pressurized gas cartridge and adapted to seal the pressurized gas cartridge in fluid communication with the inlet;
a plunger having an external end and an internal end, the plunger being sealed to the housing between the internal end and the external end, the internal end extending into the gas enclosure and the external end extending outwardly of the housing, the plunger being adapted to transfer a force applied to the external end of the plunger to the piston to break the frangible seal of the product cartridge;
wherein the dispensing device is further adapted to provide pressurized gas from the pressurized gas cartridge to the gas enclosure to generate a force sufficient to move the piston to dispense product from a dispensing orifice of the product cartridge.

9. A pneumatic dispensing device according to claim 8, wherein the plunger is adapted to transfer a momentary force that is impacted upon the external end of the plunger to the piston.

10. A pneumatic dispensing device according to claim 8, wherein the frangible seal is associated with the piston.

11. A pneumatic dispensing device according to claim 8, wherein the plunger is adapted to transfer a force to the piston that is greater than the force sufficient to move the piston to dispense product from a dispensing orifice of the product cartridge.

12. A pneumatic dispensing device according to claim 8, wherein the pressurized gas cartridge is a CO₂ gas cartridge.

13. A pneumatic dispensing device according to claim 8, further comprising a biasing member to bias the plunger away from the piston.

14. A pneumatic dispensing device according to claim 13, wherein the biasing member is a spring.

15. A method of enabling product to be dispensed from a product cartridge having a frangible seal using a dispensing device, comprising;
associating a seal breaking mechanism with the dispensing device that is adapted to exert a frangible seal breaking force on the product cartridge;
associating a separate dispensing mechanism with the dispensing device that is adapted to exert a product dispensing force on the product cartridge.

16. A method of enabling product to be dispensed according to claim 15, wherein the dispensing mechanism applies pneumatic pressure to exert the product dispensing force.

17. A method of enabling product to be dispensed according to claim 16, wherein the seal breaking mechanism impacts against the product cartridge to exert the frangible seal breaking force.

18. A method of enabling product to be dispensed according to claim 15, further comprising instructing a user in the use of the seal breaking mechanism to break the frangible seal.

19. A method of enabling product to be dispensed according to claim 18, further comprising associating the product cartridge with the pneumatic dispensing device.

20. A method of enabling product to be dispensed according to claim 19, further comprising associating a pressurized gas cartridge with the pneumatic dispensing device to provide pressurized gas to a gas enclosure.
